(19) United States
(12) Patent Application Publication
(10) Pub. No.: US 2020/0021698 A1
(43) Pub. Date: Jan. 16, 2020

(54) DISPLAY APPARATUS AND NON-TRANSITORY COMPUTER READABLE MEDIUM

(71) Applicant: FUJI XEROX CO., LTD., TOKYO (JP)

(72) Inventor: Jun NAGUMO, Kanagawa (JP)

(73) Assignee: FUJI XEROX CO., LTD., TOKYO (JP)

(21) Appl. No.: 16/459,578

(22) Filed: Jul. 1, 2019

(30) Foreign Application Priority Data
Jul. 13, 2018 (JP) 2018-133526

(51) Int. Cl. H04N 1/00; G06F 3/041; G06F 3/0488

(52) U.S. Cl. CPC H04N 1/00411; G06F 3/0488; G06F 3/0412; H04N 1/00472

(57) ABSTRACT

A display apparatus includes a display unit, a reception unit that receives a user operation performed in an input field displayed on the display unit, and a display control unit that, if the user operation is received, displays, on the display unit, a software keyboard and another input field corresponding to the input field in which the user operation has been performed.

### CROSS-REFERENCE TO RELATED APPLICATIONS

This application is based on and claims priority under 35 USC 119 from Japanese Patent Application No. 2018-133526 filed Jul. 13, 2018.

### BACKGROUND

### (i) Technical Field

The present disclosure relates to a display apparatus and a non-transitory computer readable medium.

### (ii) Related Art

Techniques for replacing hardware buttons with software buttons, that is, for example, a hardware keyboard with a software keyboard, are known in view of improving design and reducing cost.

In Japanese Unexamined Patent Application Publication No. 2003-295996, a control display apparatus that simultaneously displays a keyboard employing a touch panel method and another image even in a small display area is described. An alpha blending device performs alpha blending on color data regarding an overlap between a setting value display window displayed on a graphic operation panel such as a programmable display and a keyboard superimposed upon the setting value display window in accordance with a set level of transparency. A display control system program stored in a flash erasable programmable read-only memory (FEPROM) is used to superimpose the keyboard upon the setting value display window. The setting value display window is made translucent in the overlap with the keyboard on the basis of a result of the alpha blending.

In Japanese Unexamined Patent Application Publication No. 2007-183787, an automatic analysis apparatus including a software keyboard that is easy to use regardless of where the software keyboard is displayed is described. The automatic analysis apparatus includes a display screen, information displayed on the display screen, and the software keyboard that is displayed on the display screen and to which a predetermined piece of information is input if a user touches a certain position on the display screen. The software keyboard is displayed opaquely or translucently, and accordingly the information is hidden behind the software keyboard or seen through the software keyboard.

### SUMMARY

When a software keyboard is displayed in such a way as to avoid an input area (input field) or translucently, the software keyboard becomes smaller and it becomes difficult to input or the visibility of the software keyboard decreases. If the user moves the software keyboard to a desired position every time it is needed, an operation load of the user increases.

Aspects of non-limiting embodiments of the present disclosure relate to a technique for, when a software keyboard is displayed on a display unit, enabling the user to input text or a value using the software keyboard while easily viewing an input field, compared to when the software keyboard is superimposed upon the input field.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a display apparatus including a display unit, a reception unit that receives a user operation performed in an input field displayed on the display unit, and a display control unit that, if the user operation is received, displays, on the display unit, a software keyboard and another input field corresponding to the input field in which the user operation has been performed.

### BRIEF DESCRIPTION OF THE DRAWINGS

An exemplary embodiment of the present disclosure will be described in detail based on the following figures, wherein:

FIG. 1 is a diagram illustrating the configuration of an image forming apparatus according to an exemplary embodiment;

FIG. 2 is a block diagram illustrating a function of the image forming apparatus according to the exemplary embodiment;

FIG. 3 is a diagram illustrating a home screen of the image forming apparatus according to the exemplary embodiment;

FIG. 4 is a flowchart illustrating a process according to the exemplary embodiment;

FIG. 5 is a flowchart illustrating another process according to the exemplary embodiment;

FIG. 6 is a first diagram illustrating an example of a screen according to the exemplary embodiment;

FIG. 7 is a second diagram illustrating the example of the screen according to the exemplary embodiment;

FIG. 8 is a third diagram illustrating the example of the screen according to the exemplary embodiment;

FIG. 9 is a fourth diagram illustrating the example of the screen according to the exemplary embodiment;

FIG. 10 is a fifth diagram illustrating the example of the screen according to the exemplary embodiment;

FIG. 11 is a first diagram illustrating another example of the screen according to the exemplary embodiment;

FIG. 12 is a second diagram illustrating the other example of the screen according to the exemplary embodiment;

FIG. 13 is a third diagram illustrating the other example of the screen according to the exemplary embodiment;

FIG. 14 is a fourth diagram illustrating the other example of the screen according to the exemplary embodiment;

FIG. 15 is a first flowchart illustrating a process according to a first modification;

FIG. 16 is a second flowchart illustrating the process according to the first modification;

FIG. 17 is a first diagram illustrating an example of a screen according to the first modification;

FIG. 18 is a second diagram illustrating the example of the screen according to the first modification;

FIG. 19 is a third diagram illustrating the example of the screen according to the first modification;

FIG. 20 is a fourth diagram illustrating the example of the screen according to the first modification;

FIG. 21 is a diagram illustrating an example of a screen according to a second modification; and

FIG. 22 is a diagram illustrating an example of a screen according to a third modification.

### DETAILED DESCRIPTION

An image forming apparatus including a display device according to an exemplary embodiment of the present disclosure will be described hereinafter with reference to the drawings.

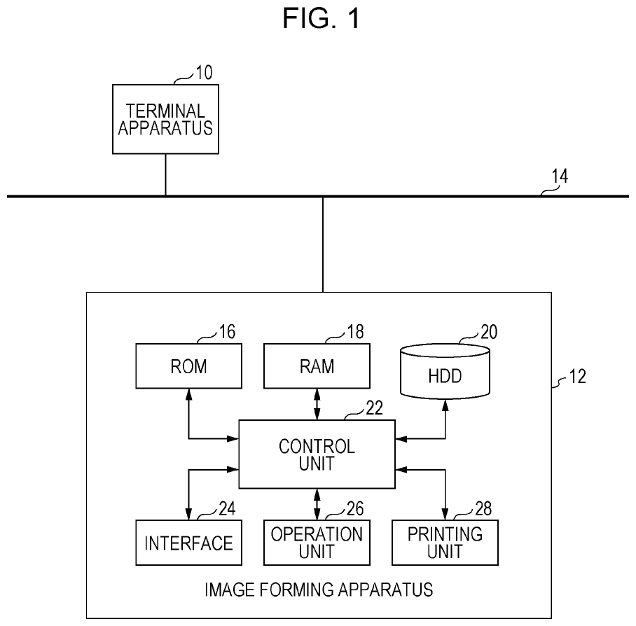

FIG. 1 is a diagram illustrating the configuration of a system including the image forming apparatus according to the present exemplary embodiment. The system includes a terminal apparatus 10 and an image forming apparatus 12. The terminal apparatus 10 and the image forming apparatus 12 are communicably connected to each other by a communication network 14. The communication network 14 may be a data communication network such as a local area network (LAN), but is not limited to this.

The terminal apparatus 10 is connected to the image forming apparatus 12 through the communication network 14 and transmits a print job including a document print command in accordance with an instruction from a user.

The image forming apparatus 12 includes a read-only memory (ROM) 16, a random-access memory (RAM) 18, a hard disk drive (HDD) 20, a control unit 22 including one or a plurality of processors, an interface 24, an operation unit 26 such as a touch panel, and a printing unit 28. The image forming apparatus 12 may serve as a multifunction peripheral (MFP) having a plurality of functions of, for example, a copier, a facsimile, and a printer. The image forming apparatus 12 includes a print job reception module, an interpretation module, and a drawing module as basic function modules. These function modules are achieved when the control unit 22 including the one or plurality of processors executes a processing program stored in the ROM 16.

The print job reception module receives a print job from the terminal apparatus 10. The print job includes a command for printing a document and data describing the document in a page description language (PDL). The PDL is a computer programming language for causing an information processing apparatus to perform a display process, a printing process, and the like. Data described in the PDL includes letters and figures included in the document, positional information regarding objects such as images, style information, and color information. The print job reception module supplies the PDL data included in the received print job to the interpretation module.

The interpretation module interprets the PDL data obtained from the print job reception module. The interpretation module then generates, in accordance with a result of the interpretation, intermediate data including a command indicating a procedure for generating drawing data and outputs the intermediate data. The interpretation module generates the intermediate data and supplies the intermediate data to an intermediate data buffer.

The drawing module reads the intermediate data stored in the intermediate data buffer and generates drawing data (raster data) in accordance with the read intermediate data. For example, the drawing module draws an object by obtaining values of pixels within a range indicated by shape data regarding the object from color data regarding the object and writing the values at addresses of a page memory corresponding to the pixels. By drawing all objects included in one page, a raster image of the page is formed. The generated drawing data regarding each page is stored in an output buffer and sequentially supplied to the printing unit 28. The printing unit 28 prints the drawing data regarding each page read from the output buffer on a recording medium such as a roll.

The printing unit 28 employs a known inkjet method and prints the drawing data on a sheet. The printing unit 28 discharges liquid or molten solid ink from nozzles or the like to print the drawing data on a sheet of paper, a film, or the like. Methods for discharging ink include a drop-on-demand method (pressure pulse method), in which ink is discharged through electrostatic induction, and a thermal inkjet method, in which ink is discharged using pressure caused by forming and developing bubbles with heat. A recording head discharges ink drops of each color onto an intermediate transfer unit, which in turn transfers the ink drops onto a sheet to achieve printing.

The operation unit 26 receives various operations from the user. The operation unit 26 includes a touch panel, and software buttons used by the user to issue instructions to the image forming apparatus 12 are displayed on the touch panel. The control unit 22 displays the software buttons on the touch panel by executing a processing program stored in the ROM 16 or the HDD 20.

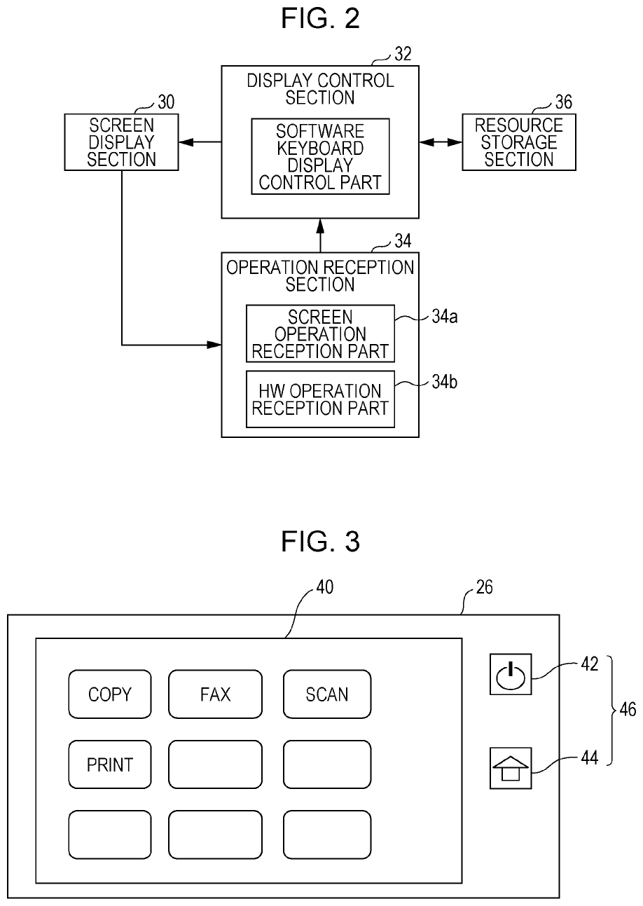

FIG. 2 is a block diagram illustrating a display function of the control unit 22 that displays the software buttons on the touch panel. The control unit 22 includes a screen display section 30, a display control section 32, an operation reception section 34, and a resource storage section 36 as functional blocks of the display function.

The screen display section 30 displays a software screen including the software buttons on the touch panel. In the case of a web application, for example, the screen display section 30 is a rendering engine of a web browser.

The operation reception section 34 includes a screen operation reception part 34a that receives an operation for selecting a software button displayed on the touch panel and a hardware (HW) operation reception part 34b that detects an operation for pressing a hardware button and the like. Upon receiving an operation performed by the user, the operation reception section 34 outputs an operation notification to the display control section 32.

The resource storage section 36 stores resources to be displayed on the screen display section 30. In the case of a web application, for example, the resource storage section 36 is a storage storing various resources such as hypertext markup language (HTML), cascading style sheets (CSS), JavaScript (registered trademark), and image files. The resource storage section 36 may be a server connected to the image forming apparatus 12 through the communication network 14, instead.

Upon receiving an operation notification from the operation reception section 34, the display control section 32 determines a screen to be displayed on the screen display section 30 on the basis of the operation notification, obtains relevant resources from the resource storage section 36, and outputs the resources to the screen display section 30 to control the screen display section 30. The display control section 32 also achieves dynamic display of a software screen by processing the resources obtained from the resource storage section 36 and outputting the processed resources to the screen display section 30 or by regularly updating the resources output to the screen display section 30. In the case of a web application, for example, the display control section 32 achieves dynamic display on a web browser by dynamically changing CSS attribute values of HTML elements using JavaScript. The display control section 32 includes a software keyboard display control part. If an operation notification received from the operation reception section 34 is a certain type of notification, namely an operation performed in an input field, the display control section 32 obtains screen resources of a software keyboard from the resource storage section 36 and outputs the screen resources to the screen display section 30 to display the software keyboard on the screen display section 30.

The screen display section 30, the display control section 32, and the operation reception section 34 are achieved when the control unit 22 has executed a processing program stored in the ROM 16 or the HDD 20.

FIG. 3 illustrates the operation unit 26 of the image forming apparatus 12. The operation unit 26 includes a touch panel 40 and HW buttons 46.

The screen display section 30 displays a software screen on the touch panel 40, and the software screen includes various software buttons. In FIG. 3, software buttons of “copy”, “fax”, “scan”, and “print” are displayed in an initial screen (home screen). The user instructs the image forming apparatus 12 to perform a certain function by selecting a corresponding software button.

The HW buttons 46 includes, for example, a sub-power button 42 and a home button 44. The sub-power button 42 is a button used to display a screen including buttons of “turn off”, “restart”, and “save power”. The home button 44 is a button used to return to the home screen.

As illustrated in FIG. 3, the operation unit 26 of the image forming apparatus 12 according to the present exemplary embodiment does not include a keyboard (a numeric keypad included) as HW buttons 46. If the user touches an input field on the touch panel 40, the display control section 32 displays a software keyboard (a software numeric keypad included) on the touch panel 40 instead of a keyboard (a numeric keypad included) as HW buttons 46.

More specifically, the display control section 32 receives a notification from the operation reception section 34, obtains, from the resource storage section 36, screen resources according to an operation indicated by the notification, and outputs the screen resources to the screen display section 30 to display a screen. When the display control section 32 displays an input field for inputting a value, the display control section 32 also displays increase and decrease keys (including scroll keys) near the input field. The increase and decrease keys are operation keys for increasing or decreasing a value in the input field. There might be only the increase key or the decrease key, or there might be both. The increase key is usually indicated by “+”, and the decrease key is usually indicated by “−”, but any indication mode may be employed. “1”, for example, may be displayed in the input field as an initial value (default value), and the user may input a desired value by increasing or decreasing the default value in the input field by operating (touching) the increase and decrease keys.

The user, on the other hand, might desire to directly input a value using a numeric keypad instead of increasing or decreasing a value using the increase and decrease keys. In this case, it is possible for the display control section 32 to display a software numeric keypad if the user touches an input field. As described above, however, if a software numeric keypad is superimposed upon an input field, the input field is hidden behind the software numeric keypad, and it becomes difficult to identify an item for which the user is to input a value. If a position at which the software numeric keypad is displayed is adjusted in such a way as to avoid the input field or the software numeric keypad is reduced in size, or if the software numeric keypad is made transparent or translucent, for example, the visibility of the software numeric keypad decreases. The same holds when a software keyboard for inputting letters is displayed.

When an operation is performed in an input field displayed on a screen, therefore, the display control section 32 displays another input field corresponding to the original input field along with a software keyboard to suppress a decrease in visibility. The other input field has the same attributes as the original input field and can be regarded as a copy of the original input field.

Next, a process according to the present exemplary embodiment will be described in detail.

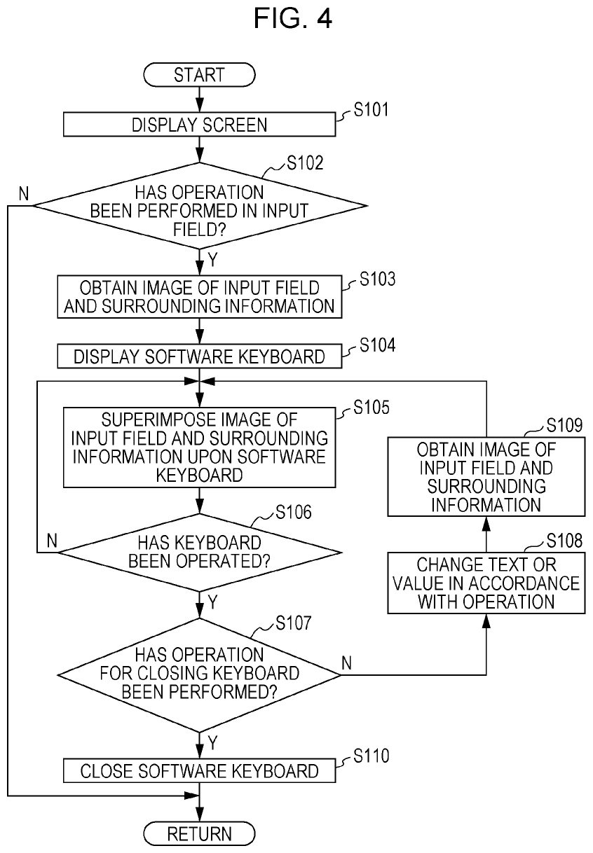

FIG. 4 is a flowchart illustrating the process according to the present exemplary embodiment.

First, the display control section 32 receives a notification from the operation reception section 34. The display control section 32 obtains screen resources according to the notification from the resource storage section 36 and outputs the screen resources to the screen display section 30 to display a screen on the touch panel 40 (S101).

If the user selects the “copy” button on the home screen illustrated in FIG. 3, for example, the operation reception section 34 notifies the display control section 32 that the “copy” button has been selected.

Upon receiving the notification, the display control section 32 obtains a corresponding screen resource file from the resource storage section 36. The corresponding screen resource file can be identified by storing a table indicating correspondence between applications and screen resource files in the resource storage section 36. In the case of a web application, the resource storage section 36 stores various resource files such as HTML, CSS, JavaScript, and images. HTML is used to express web application screens, and elements (buttons, images, text, etc.) included in screens are described in a tree structure. A screen is displayed when a rendering engine included in a web browser or the like analyzes and draws HTML.

The display control section 32 outputs a screen resource file (HTML file) of an obtained copy application and CSS, JavaScript, and image files linked with the HTML file to the screen display section 30. The screen display section 30 displays a top screen of the copy application by analyzing and drawing the screen resource file and the other files. In an example of the top screen of the copy application, a header, a body, a menu, and a scroll bar are displayed. The menu includes various menu items and, as necessary, an input field for inputting letters or a value and increase and decrease keys.

Next, the screen display section 30 receives a notification from the operation reception section 34. The screen display section 30 analyzes the notification to determine whether the user has performed an operation in the input field displayed on the screen (S102). If not (NO in S102), the screen display section 30 displays a screen according to an operation performed by the user.

If so (YES in S102), that is, for example, if the user has touched the input field with his/her finger, the display control section 32 obtains an image of the input field and surrounding information (S103). More specifically, the display control section 32 obtains screen resources of the input field and the surrounding information from the resource storage section 36. The surrounding information is information within a predetermined range around the input field, namely several to tens of pixels around the input field, but is not limited to this. Objects around the input field may be obtained as the surrounding information, instead. The display control section 32 then obtains screen resources of a software keyboard from the resource storage section 36 and displays the software keyboard at any position on the screen, namely, for example, at substantially the center of the screen (S104). The display control section 32 also displays the image of the input field and the surrounding information obtained in S103 (S105).

When displaying the software keyboard and the image of the input field and the surrounding information obtained in S103, the display control section 32 displays the image of the input field and the surrounding information in an area other than keys of the software keyboard. If the display control section 32 displays a software numeric keypad as the software keyboard, for example, the display control section 32 displays the image of the input field and the surrounding information in an area other than the software numeric keypad. The surround information regarding the input field includes explanations of the input field, that is, for example, text relating to an input item and a range of values that can be input.

After displaying the software keyboard and the image of the input field and the surrounding information, the display control section 32 determines whether the user has operated the displayed software keyboard (S106).

If the user has operated the software keyboard (YES in S106), the display control section 32 determines whether the user has performed the operation to close the software keyboard, that is, whether the user has selected a close button (S107).

If the user has not performed the operation to close the software keyboard (NO in S107), that is, for example, if the user has operated a numeric key of the software numeric keypad, the display control section 32 changes text or a value in the input field in accordance with the operation performed by the user (S108). The display control section 32 then obtains the image of the input field and the surrounding information again (S109) and repeats S105 and later steps.

That is, if the user has operated the software numeric keypad, the display control section 32 changes a value in the input field displayed on the screen in accordance with the operation performed by the user, that is, the input field in which the user has performed an operation in S102. The display control section 32 then obtain the image of the input field and the surrounding information again. The other input field displayed along with the software keyboard is a copy of the input field displayed on the screen at a beginning, and a value in the other input field changes as a value in the original input field changes.

If the user has performed the operation to close the software keyboard (YES in S107), on the other hand, the display control section 32 closes the software keyboard (S110).

By repeating S105, S108, and S109, the image of the input field and the surrounding information is displayed along with the software keyboard. If the user operates the software keyboard, the operation is reflected in the input field and the image of the input field and the surrounding information based on the operation is displayed. The user therefore operates the software keyboard while viewing the image of the input field and the surrounding information. That is, even if there is an input field on the screen displayed in S101 and the input field is hidden behind a software keyboard by displaying the software keyboard at substantially the center of the screen as a result of an operation performed in the input field, the image of the input field and the surrounding information is displayed again with the software keyboard. The user therefore inputs text or a value using the software keyboard while viewing the input field and the surrounding information.

Although the image of the surrounding information around the input field is obtained in S103 and S109, screen resources of an input item and input range information may be obtained from the resource storage section 36, arranged, and displayed, instead.

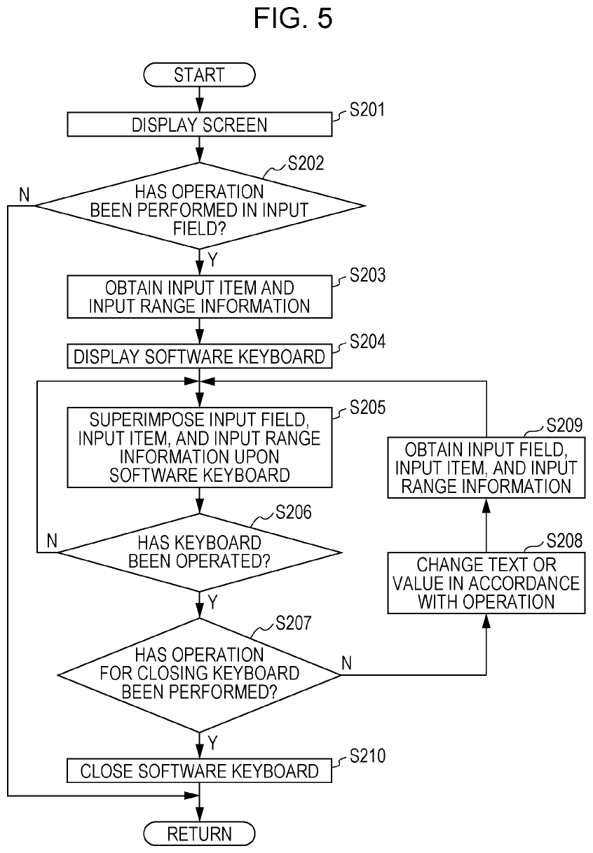

FIG. 5 is a flowchart illustrating a process performed in this case.

First, the display control section 32 receives a notification from the operation reception section 34. The display control section 32 then obtains screen resources according to the notification from the resource storage section 36 and outputs the screen resources to the screen display section 30 to display a screen on the touch panel 40 (S201).

Next, the screen display section 30 receives a notification from the operation reception section 34. The screen display section 30 analyzes the notification to determine whether the user has performed an operation in the input field (S202). If not (NO in S202), the screen display section 30 displays a screen according to an operation performed by the user.

If so (YES in S202), the display control section 32 obtains an input item and input range information regarding the input field in which the user has performed an operation (S203). More specifically, the display control section 32 obtains, from the resource storage section 36, screen resources of the input item and the input range information regarding the input field in which the user has performed an operation. The display control section 32 then obtains screen resources of a software keyboard from the resource storage section 36 and displays the software keyboard at any position on the screen, namely, for example, at substantially the center of the screen (S204). The display control section 32 also superimposes the input field and the input item and the input range information obtained in S203 upon the displayed software keyboard (S205). When superimposing the input field and the input item and the input range information obtained in S203 upon the displayed software keyboard, the display control section 32 superimposes the input item and the input range information in an area other than keys of the software keyboard. When the display control section 32 displays a software numeric keypad as a software keyboard, for example, the display control section 32 displays the input field, the input item, and the input range information in an area other than the software numeric keypad.

After displaying the software keyboard, the input field, the input item, and the input range information, the display control section 32 determines whether the user has operated the displayed software keyboard (S206).

If the user has operated the software keyboard (YES in S206), the display control section 32 determines whether the user has performed the operation to close the software keyboard, that is, whether the user has selected a close button (S207).

If the user has not performed the operation to close the software keyboard (NO in S207), that is, for example, if the user has operated a numeric key of the software numeric keypad, the display control section 32 changes text or a value in the input field in accordance with the operation performed by the user (S208). The display control section 32 then obtains the input field, the input item, and the input range information again (S209) and repeats S205 and later steps.

If the user has performed the operation to close the software keyboard (YES in S207), on the other hand, the display control section 32 closes the software keyboard (S210).

By repeating S205, S208, and S209, the input field, the input item, and the input range information are displayed along with the software keyboard. If the user operates the software keyboard, the operation is reflected in the input field, and the input field, the input item, and the input range information based on the operation are displayed. The user therefore operates the software keyboard while viewing the input field, the input item, and the input range information. That is, even if there is an input field on the screen displayed in S201 and the input field is hidden behind a software keyboard by displaying the software keyboard at substantially the center of the screen as a result of an operation performed in the input field, the input field, the input item, and the input range information are displayed again with the software keyboard. The user therefore inputs text or a value using the software keyboard while viewing the input field, the input item, and the input range information.

Next, specific examples of screens displayed on the touch panel 40 will be described.

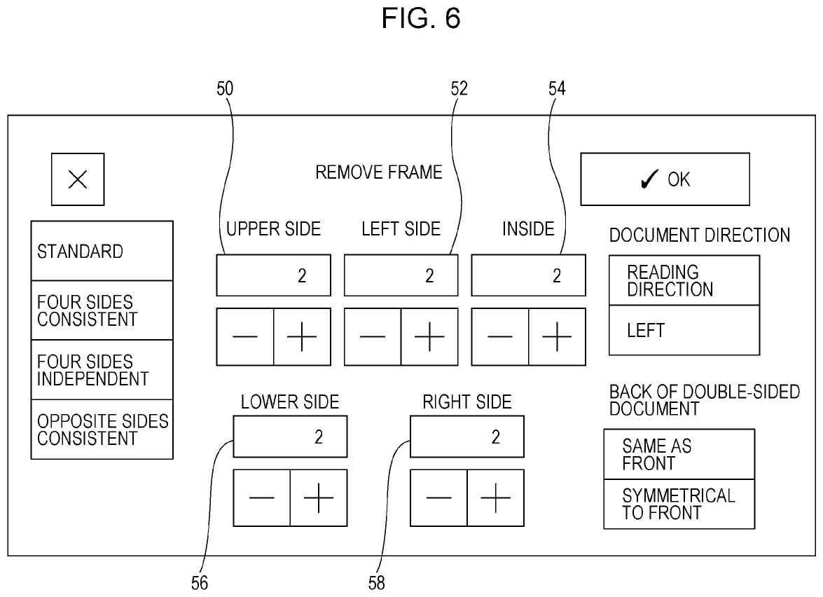

FIG. 6 illustrates an example of a screen displayed when the user has selected “remove frame” from menu items of a copy application. Here, “remove frame” refers to a process for removing a black frame caused when copy is performed. Input fields 50 to 58 for inputting degrees of frame removal (e.g., within a range of 0 to 50 mm) and increase and decrease keys are displayed along with items of “upper side”, “left side”, “inside”, “lower side”, and “right side”. For “upper side”, for example, the input field 50, an increase key, and a decrease key are displayed. “Document direction” and “back of double-sided document” are also displayed.

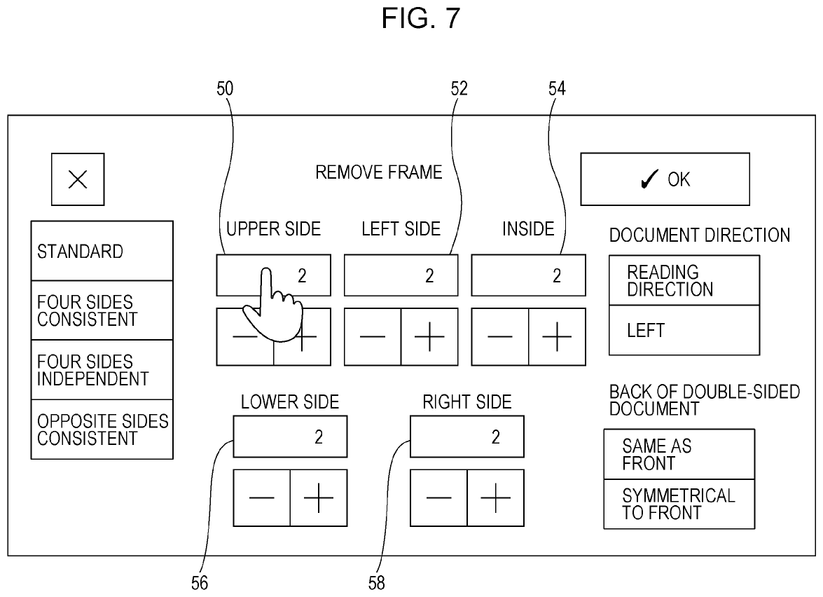

If the user sets a degree of frame removal for “upper side”, the user touches the input field 50 corresponding to “upper side” as illustrated in FIG. 7. The display control section 32 receives a notification from the operation reception section 34 and determines on the basis of the notification that the user has performed an operation in the input field 50. The display control section 32 then obtains an image of the input field 50 and surrounding information, displays a software keyboard, and superimposes the obtained image upon the software keyboard.

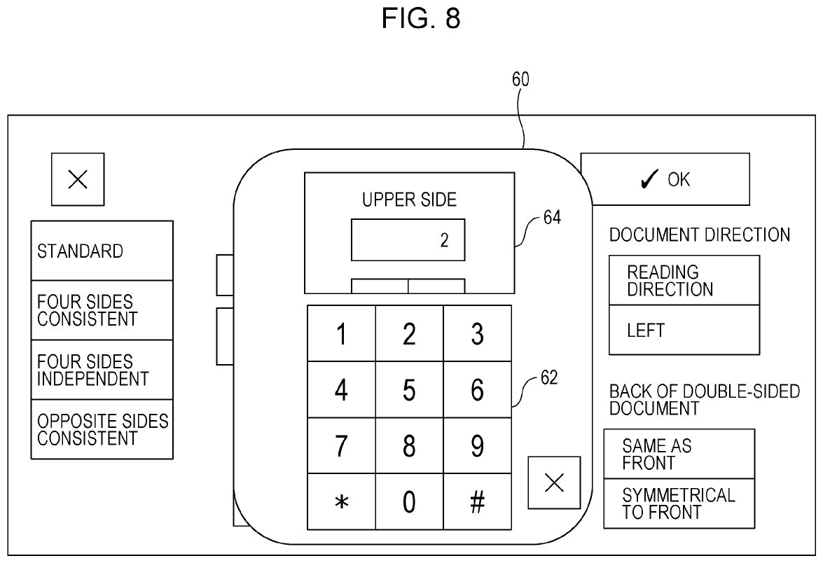

FIG. 8 illustrates an example of a software keyboard displayed when the user has performed an operation in the input field 50. A popup window 60 is superimposed upon the screen in which the input field 50 is displayed. A software numeric keypad 62 as a software keyboard is displayed in the popup window 60. The software numeric keypad 62 is displayed because the input field 50 is an input field to which a value is to be input. An image 64 of surrounding information regarding the input field 50 is also displayed above the software numeric keypad 62. An input field in the image 64 is another input field corresponding to the input field 50. The surrounding information regarding the input field 50 includes a word “upper side”.

Even if the input field 50 and information around the input field 50 in the original screen are hidden behind the popup window 60, the user operates the software numeric keypad 62 while viewing the image 64 to understand that the input field 50 is an input field for “upper side”. This means that a software keyboard to be displayed need not be transparent or translucent and the software keyboard need not be reduced in size so that the input field 50 is not hidden.

The software numeric keypad 62 is displayed in the popup window 60 and the image 64 of the surrounding information is displayed above the software numeric keypad 62 in the above example. If the popup window 60 is regarded as a part of the software numeric keypad 62, however, it can be said that the image 64 is incorporated into the software numeric keypad 62 or that the software numeric keypad 62 and the image 64 are integrated with each other.

If the user operates the software numeric keypad 62 in this state, a new value is displayed in the input field 50, and an image of the input field 50 including the new value and the surrounding information is obtained and displayed as the image 64. A value in the input field 50 of the image 64 therefore changes from “2” to, say, “10”.

Although the image of the input field 50 and the surrounding information is obtained and displayed as it is above the software numeric keypad 62 as the image 64, the image may be increased or reduced in size as necessary and displayed above the software numeric keypad 62.

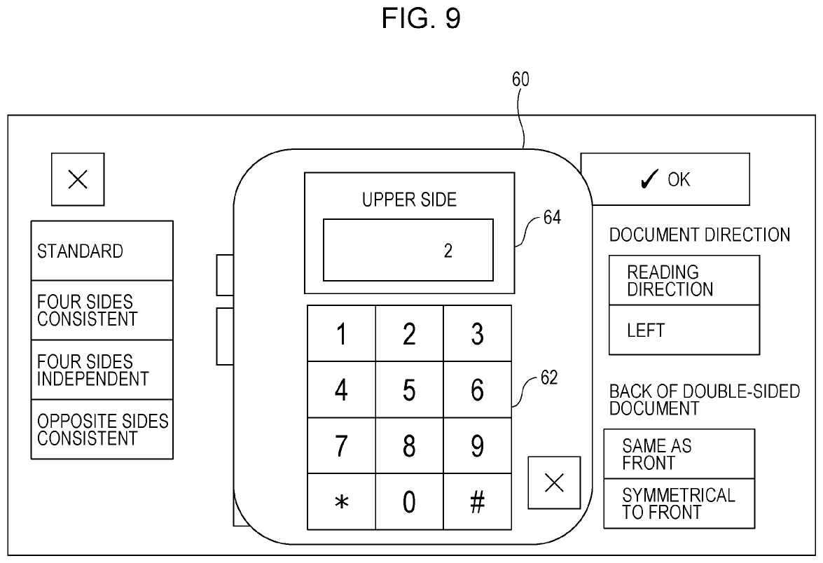

FIG. 9 illustrates an example of a screen in which the obtained image is increased in size and displayed above the software numeric keypad 62. Since the input field 50 is increased in size, the input value can be easily recognized. In addition, since the word “upper side” is also increased in size, a type of input item can be easily recognized.

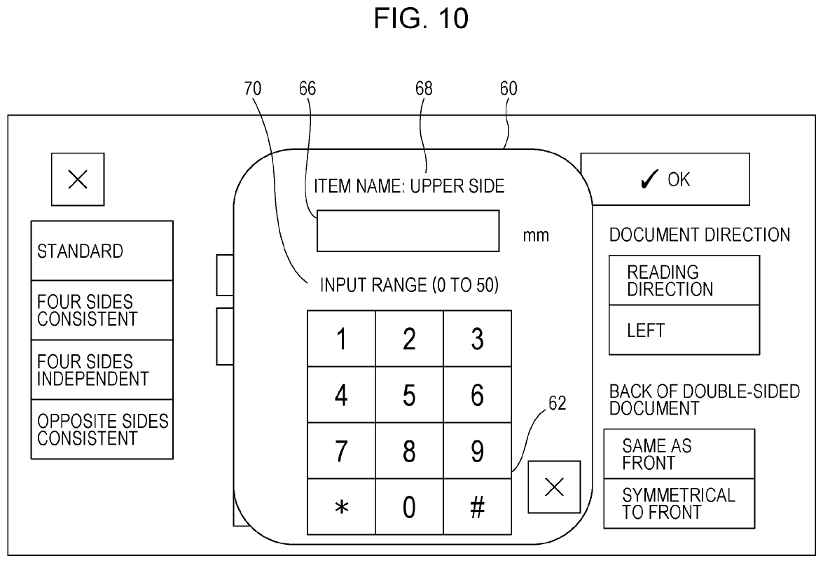

FIG. 10 illustrates another example of the software keyboard displayed when the user has performed an operation in the input field 50. The popup window 60 is displayed in the screen in which the input field 50 is displayed, and the software numeric keypad 62 as a software keyboard is displayed in the popup window 60. The software numeric keypad 62 is displayed since the input field 50 is an input field to which a value is to be input. An input field 66, an input item 68, and input range information 70 are also displayed above the software numeric keypad 62. The input field 66 is another input field corresponding to the input field 50. The input item 68 is “item name: upper side”. The input range information 70 is “input range (0 to 50)”, which is a range of a degree of frame removal. Even if the input field 50 and information around the input field 50 in the original screen are hidden behind the popup window 60, the user can operate the software numeric keypad 62 while viewing the input field 66, which is the other input field, the input item 68, and the input range information 70 to understand that the input field 50 is an input field for “upper side” and the input range is 0 to 50.

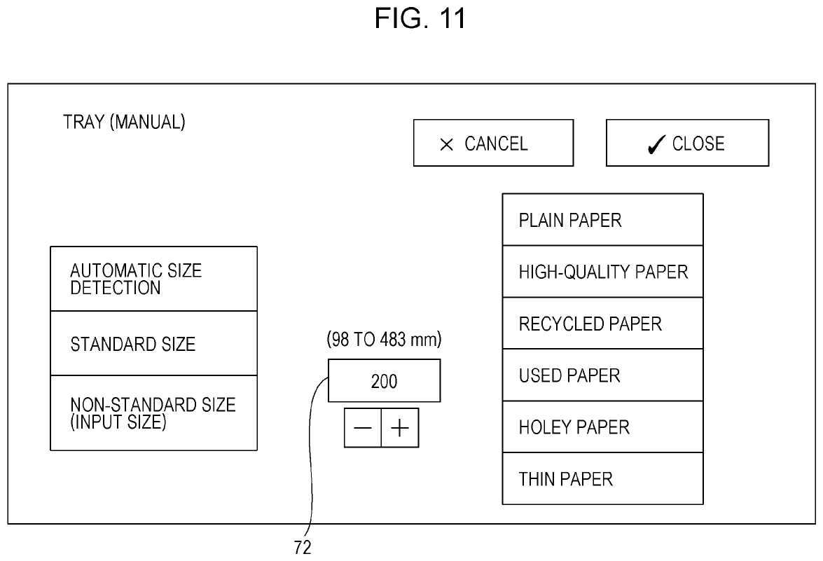

FIG. 11 illustrates an example of a screen displayed when the user has selected “tray sheet size” from the menu items of the copy application. An input field 72 indicating a size used when “non-standard size” has been selected and increase and decrease keys are displayed along with “automatic size detection”, “standard size”, and “non-standard size (input size)”. Options for a type of sheet (plain paper, high-quality paper, etc.) are also displayed.

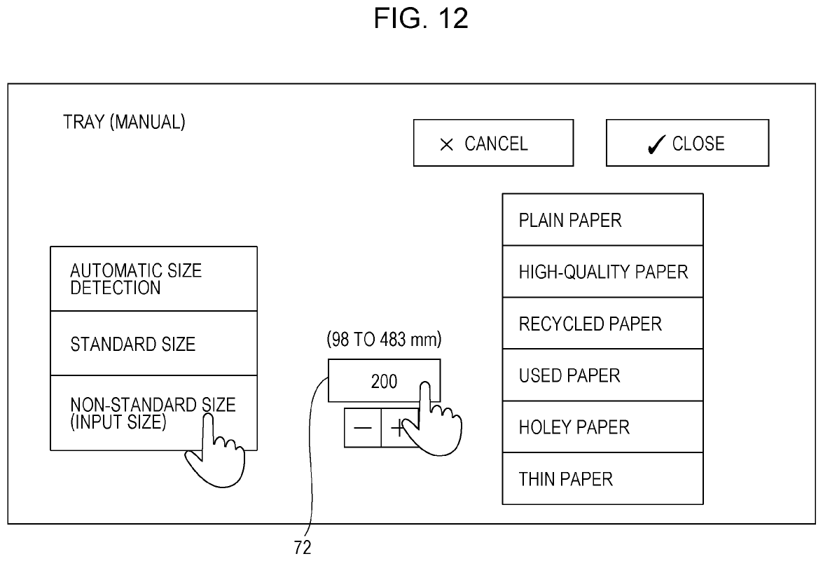

If the user sets “non-standard size”, the user touches an item corresponding to “non-standard size” and then touches the input field 72 as illustrated in FIG. 12. The display control section 32 receives a notification from the operation reception section 34 and determines on the basis of the notification that the user has performed an operation in the input field 72. The display control section 32 then obtains an image of the input field 72 and surrounding information, displays a software keyboard, and superimposes the obtained image upon the software keyboard.

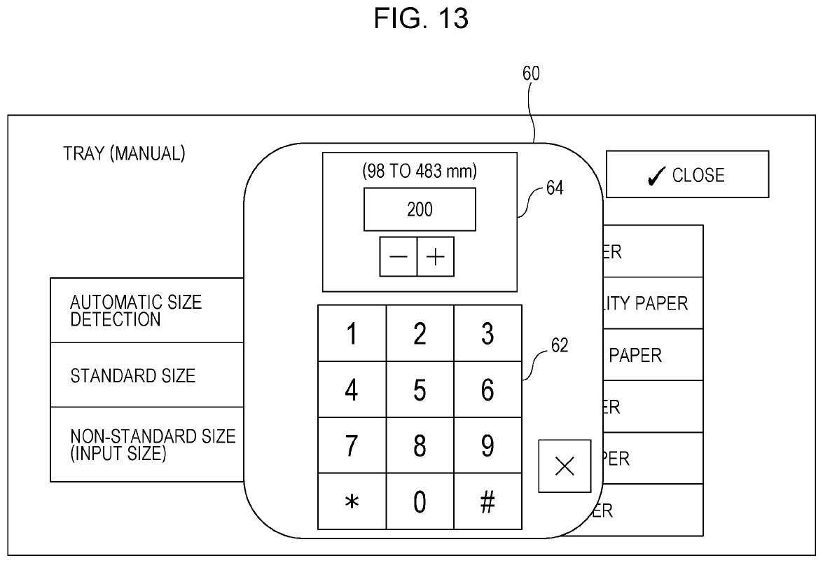

FIG. 13 illustrates an example of a software keyboard displayed when the user has performed an operation in the input field 72. The popup window 60 is displayed on the screen in which the input field 72 is displayed, and the software numeric keypad 62 as a software keyboard is displayed in the popup window 60. The software numeric keypad 62 is displayed since the input field 72 is an input field to which a value is to be input. An image 64 of surrounding information regarding the input field 72 is displayed above the software numeric keypad 62. The surrounding information regarding the input field 72 includes a word “98 to 483 mm” indicating an input range. Even if the input field 72 and information around the input field 72 are hidden behind the popup window 60, the user can operate the software numeric keypad 62 while viewing the image 64 to check the input range of the input field 72.

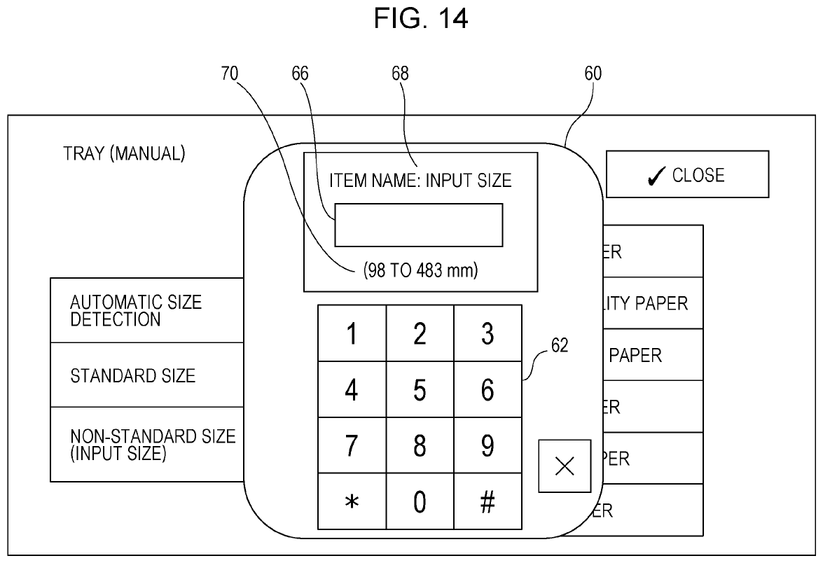

FIG. 14 illustrates another example of the software keyboard displayed when the user has operated the input field 72. The popup window 60 is displayed on the screen in which the input field 72 is displayed, and the software numeric keypad 62 as a software keyboard is displayed in the popup window 60. An input field 66, an input item 68, and input range information 70 are also displayed above the software numeric keypad 62. The input field 66 corresponds to the input field 72. The input item 68 is “item name: input size”. The input range information 70 is “98 to 483 mm”, which is a value range of size. Even if the input field 72 and information around the input field 72 in the original screen are hidden behind the popup window 60, the user operates the software numeric keypad 62 while viewing the input field 66, the input item 68, and the input range information 70 to understand that the input field 72 is an input field for “input size” and the input range is 98 to 483 mm.

Although an exemplary embodiment of the present disclosure has been described above, the present disclosure is not limited to this, and various modifications are possible. Such modifications will be described hereinafter.

### First Modification

Although an image of an input field and surrounding information is obtained and displayed along with a software keyboard in the above exemplary embodiment, marks for smoothly moving to other input fields may be provided, instead, if there are input fields other than one in which the user has performed an operation.

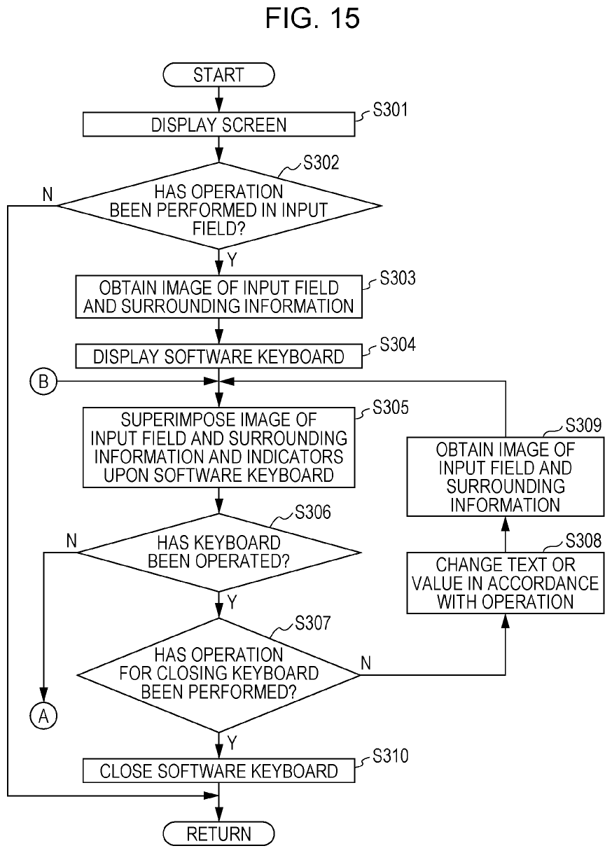

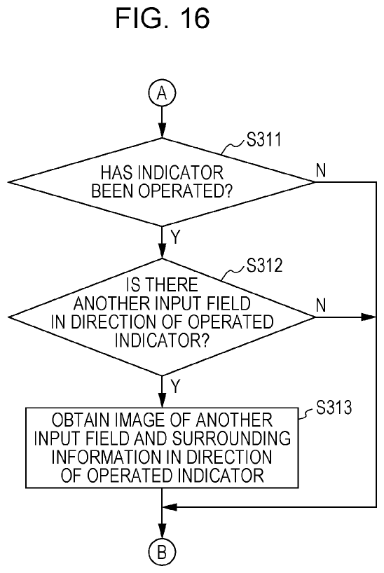

FIGS. 15 and 16 are flowcharts illustrating a process according to a first modification.

In FIG. 15, first, the display control section 32 receives a notification from the operation reception section 34. The display control section 32 then obtains screen resources according to the notification from the resource storage section 36 and outputs the screen resources to the screen display section 30 to display a screen on the touch panel 40 (S301).

Next, the screen display section 30 receives a notification from the operation reception section 34 and analyzes the notification to determine whether the user has performed an operation in an input field (S302). If not (NO in S302), the screen display section 30 displays a screen according to an operation performed by the user.

If so (YES in S302), the display control section 32 obtains an image of the input field and surrounding information (S303). More specifically, the display control section 32 obtains screen resources of the input field and the surrounding information from the resource storage section 36.

The display control section 32 then obtains screen resources of a software keyboard from the resource storage section 36 and displays the software keyboard at any position on the screen, namely, for example, at substantially the center of the screen (S304). The display control section 32 also superimposes the image of the input field and the surrounding information obtained in S303 upon the displayed software keyboard (S305). At this time, the display control section 32 determines whether there are input fields other than that in which the user has performed an operation. If so, the display control section 32 displays marks, namely indicators, for example, indicating relative positional relationships between the input field in which the user has performed an operation and the other input fields, that is, directions (upward, downward, leftward, or rightward) of the other input fields from the input field in which the user has performed an operation (S305).

When superimposing the image of the input field and the surrounding information obtained in S303 and the indicators upon the displayed software keyboard, the display control section 32 superimposes the image of the input field and the surrounding information and the indicators in an area other than keys of the software keyboard. When the display control section 32 displays a software numeric keypad as a software keyboard, for example, the display control section 32 displays the image of the input field and the surrounding information and the indicators in an area other than the software numeric keypad. The indicators may have any shape, and may be, for example, triangular.

After displaying the software keyboard, the image of the input field and the surrounding information, and the indicators, the display control section 32 determines whether the user has operated the software keyboard (S306).

If the user has operated the software keyboard (YES in S306), the display control section 32 determines whether the user has performed the operation to close the software keyboard, that is, whether the user has selected a close button (S307).

If the user has not performed the operation to close the software keyboard (NO in S307), that is, if the user has operated a numeric key of the software numeric keypad, for example, the display control section 32 changes text or a value in the input field in accordance with the operation performed by the user (S308). The display control section 32 then obtains the image of the input field and the surrounding information again (S309) and repeats S305 and later steps.

If the user has performed the operation to close the software keyboard (YES in S307), on the other hand, the display control section 32 closes the software keyboard (S310).

If the user has not operated the software keyboard (NO in S306), the process proceeds to steps illustrated in FIG. 16.

In FIG. 16, the display control section 32 determines whether the user has operated one of the indicators (S311).

If the user has operated one of the indicators (YES in S311), the display control section 32 determines whether there is another input field in a direction of the operated indicator (S312). If so (YES in S312), the display control section 32 obtains an image of the input field in the direction of the operated indicator and surrounding information (S313). The display control section 32 then repeats S305 illustrated in FIG. 15 and later steps. Since the display control section 32 has already determined in S305 whether there are input fields on the screen other than that in which the user has performed an operation, step S312 may be omitted.

If there are a plurality of input fields in the direction of the operated indicator, the display control section 32 obtains an image of an input field closest to the input field in which the user has performed an operation in S302 and surrounding information.

If a result of S311 or S312 is NO, the display control section 32 repeats S305 and later steps without performing S313.

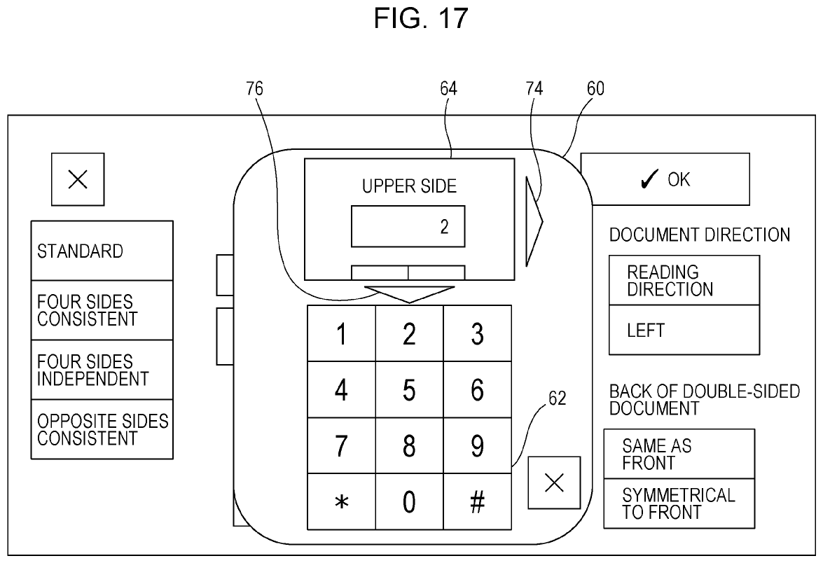

FIG. 17 illustrates an example of a screen according to the first modification. Indicators 74 and 76 are added to the software numeric keypad 62 and the image 64 illustrated in FIG. 8. The indicator 74 indicates that there is another input field to the right of the input field 50. The indicator 76 indicates that there is another input field below the input field 50. These indicators 74 and 76 correspond to a fact that, as illustrated in FIG. 6, the input field 52 for “left side” is located to the right of the input field 50 for “upper side” and the input field 56 for “lower side” below the input field 50.

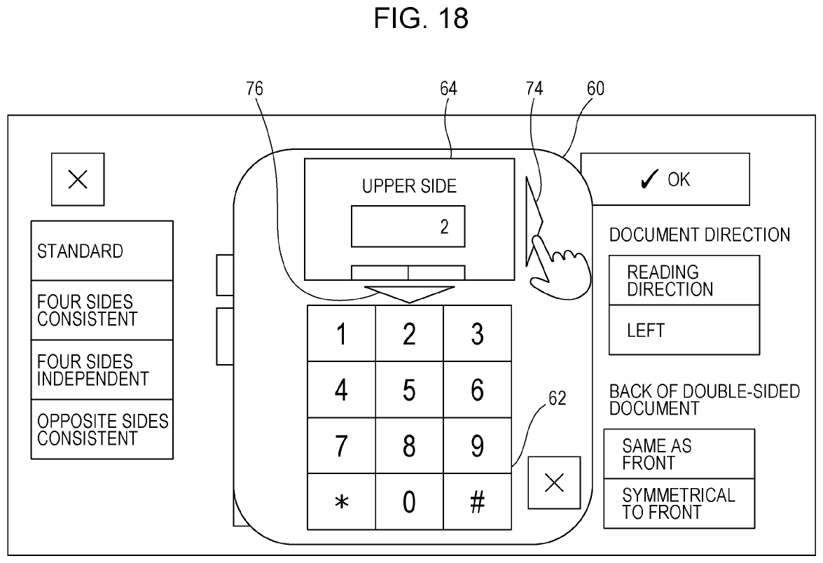

FIG. 18 illustrates a state after the user selects the rightward indicator 74 on the screen illustrated in FIG. 17. The display control section 32 receives a notification from the operation reception section 34 and detects that the notification indicates the operation performed on the indicator 74. The display control section 32 then identifies the input field 52, which is a rightward input field closest to the currently displayed input field 50. The display control section 32 obtains an image of the input field 52 and surrounding information and outputs the image to the screen display section 30.

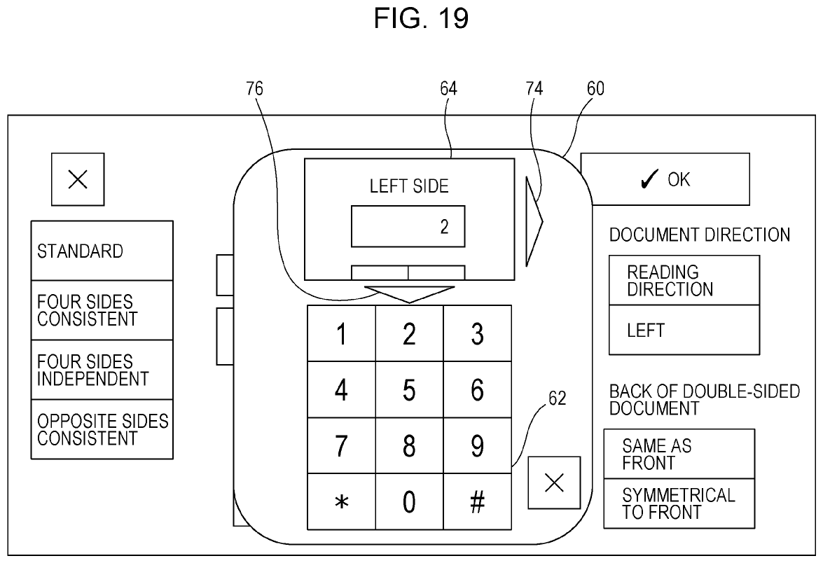

FIG. 19 illustrates an example of a screen displayed when the user has operated the indicator 74. The image of the input field 52 and the surrounding information is newly displayed as the image 64 instead of the image of the input field 50 and the surrounding information. The user can therefore input a desired value to the input field 52 by operating the indicator 74 after inputting a desired value to the input field 50 using the software numeric keypad 62.

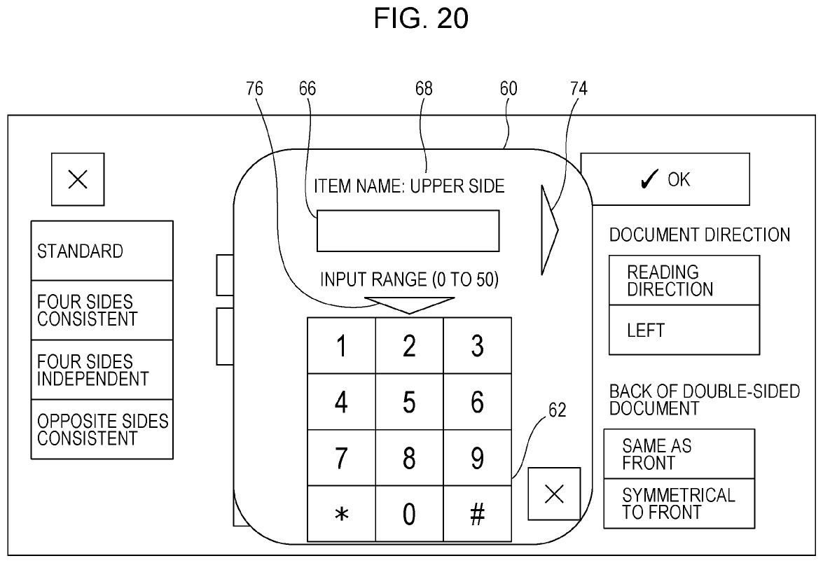

FIG. 20 illustrates an example of the indicators 74 and 76 at a time when an input field, an input item, and an input range are displayed along with the software numeric keypad 62 instead of the image 64 of an input field and surrounding information. The indicators 74 and 76 are displayed since there are other input fields and other input items to the right of and below the input item “upper side”. If the user operates the indicator 76 on this screen, for example, the display control section 32 identifies the input field 56 below the input field 50. The display control section 32 obtains an input item and an input range of the input field 56 and newly displays the input field 56, the input item, and the input range.

### Second Modification

Although the user can input a desired value by operating a software numeric keypad while viewing an input field since an image of the input field and surrounding information is displayed along with the software numeric keypad in the above exemplary embodiment, the user may be enabled to input a value using a software numeric keypad and increase and decrease keys included in an image of an input field and surrounding information when the image of the input field and the surrounding information is displayed, if the surrounding information includes the increase and decrease keys.

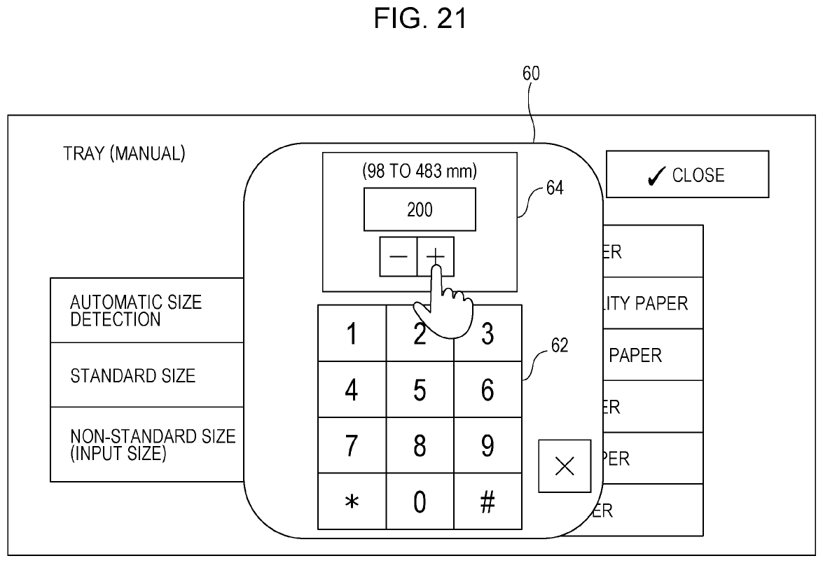

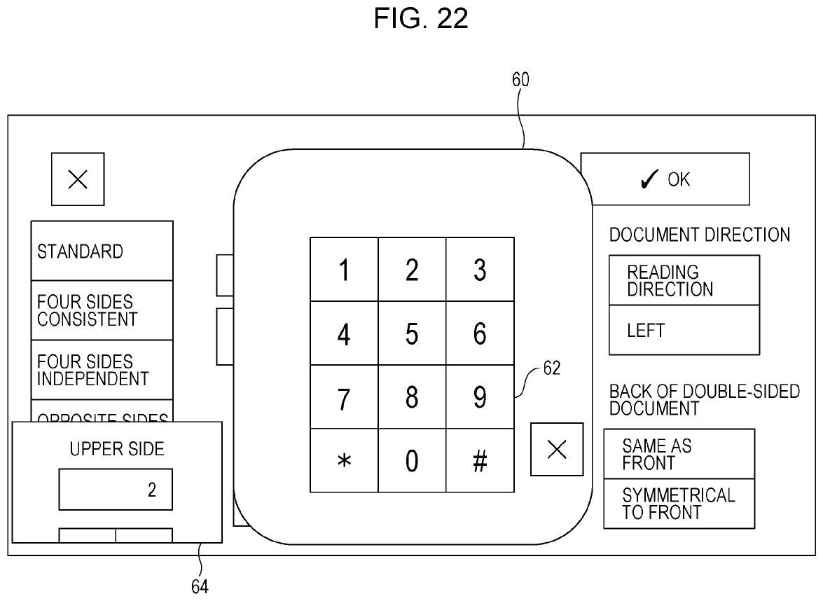

FIG. 21 illustrates an example of the software numeric keypad 62 and the image 64 at a time when the user has performed an operation in an input field on a screen for setting tray sheet size. The image 64 includes increase (+) and decrease (−) keys near the input field. If the user operates the increase and decrease keys, the display control section 32 detects the operation performed on the increase and decrease keys included in the image 64 on the basis of a notification from the operation reception section 34 and increases or decreases a value in the input field in accordance with the operation performed on the increase and decrease keys.

If the user operates the increase key, for example, the display control section 32 increases the value in the input field 72 in accordance with the operation performed on the increase key. An image of the input field 72 and the surrounding information based on the operation performed on the increase key is then obtained and displayed as a new image 64. Alternatively, the user may directly input a value by operating the software numeric keypad 62 instead of the increase and decrease keys. The user may operate the increase and decrease keys to adjust the value and the software numeric keypad to change the value largely.

### Third Modification

Although the image 64 of an input field and surrounding information is incorporated into the software numeric keypad 62 in the above exemplary embodiment as illustrated in FIG. 8 and the like, the software numeric keypad 62 and the image 64 may be separate from each other and displayed at any positions on the screen, instead.

FIG. 22 illustrates an example in which the software numeric keypad 62 is displayed at substantially the center of the screen and the image 64 is displayed in a lower-left part of the screen. The user may move the image 64 to a desired position on the screen through a drag operation. Alternatively, the software numeric keypad 62 and the image 64 may be displayed in different windows. The same holds when an input field, an input item, and an input range are displayed instead of the image 64, that is, the software numeric keypad 62, the input field (another input field), the input item, and the input range may be displayed at different positions or in different windows. The software numeric keypad 62 may be displayed at substantially the center of the screen, the input field (another input field) may be displayed in an upper part of the screen, and the input item and the input range may be displayed in a lower part of the screen.

### Fourth Modification

Although the software numeric keypad 62 and the image 64 are displayed when the user has performed an operation in an input field in the above exemplary embodiment, only the software numeric keypad 62 may be displayed without displaying the image 64, instead, if an input field on the screen can be recognized even after the software numeric keypad 62 is displayed. That is, the display control section 32 displays the software numeric keypad 62 if the display control section 32 detects an operation performed by the user in an input field. At this time, the display control section 32 determines whether the input field is hidden behind the displayed software numeric keypad 62. If at least a part of the input field is hidden, the display control section 32 may display the image 64.

More specifically, the display control section 32 displays a software keyboard in S104 in the flowchart of FIG. 4 and determines whether at least a part of an input field in which the user has performed an operation in S102 is hidden behind the software keyboard. If so, the display control section 32 may perform S105.

### Fifth Modification

Although a case where a software numeric keypad is displayed as a software keyboard in the above exemplary embodiment, the display control section 32 may display a software keyboard with which letters can be input, instead, if an input field in which the user has performed an operation is an input field to which letters can be input. Such a situation occurs, for example, when the user has performed an operation on a fax application screen in an input field to which an address of a fax is to be input.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A display apparatus comprising:
a display unit;
a reception unit that receives a user operation performed in an input field displayed on the display unit; and
a display control unit that, if the user operation is received, displays, on the display unit, a software keyboard and another input field corresponding to the input field in which the user operation has been performed.

2. The display apparatus according to claim 1,
wherein the display control unit displays an input item along with the other input field.

3. The display apparatus according to claim 1,
wherein the display control unit displays an input range along with the other input field.

4. The display apparatus according to claim 1,
wherein the display control unit obtains an image of the input field in which the user operation has been performed and displays the image as the other input field.

5. The display apparatus according to claim 1,
wherein the display control unit obtains an image of the input field in which the user operation has been performed and surrounding information and displays the image as the other input field and an input item.

6. The display apparatus according to claim 1,
wherein the display control unit obtains an image of the input field in which the user operation has been performed and surrounding information and displays the image as the other input field and an input range.

7. The display apparatus according to claim 4,
wherein the display control unit increases or reduces the image in size.

8. The display apparatus according to claim 4,
wherein the display control unit displays the image in a movable manner through a user operation.

9. The display apparatus according to claim 1,
wherein, if there are a plurality of input fields on a screen displayed on the display unit, the display control unit displays marks indicating presence of the input fields other than the input field in which the user operation has been performed.

10. The display apparatus according to claim 9,
wherein the marks indicate directions of the other input fields from the input field in which the user operation has been performed.

11. The display apparatus according to claim 9,
wherein, if one of the marks is operated, the display control unit displays a corresponding one of the other input fields.

12. The display apparatus according to claim 1,
wherein the display control unit incorporates the other input field into the software keyboard.

13. The display apparatus according to claim 1,
wherein the display control unit displays the other input field separately from the software keyboard.

14. The display apparatus according to claim 13,
wherein the display control unit displays the other input field in a movable manner through a user operation.

15. The display apparatus according to claim 1,
wherein the display control unit obtains an image of the input field in which the user operation has been performed and surrounding information and displays the image as the other input field and increase and decrease keys.

16. The display apparatus according to claim 1,
wherein the display control unit changes text or a value displayed in the other input field in accordance with an operation performed on the software keyboard.

17. The display apparatus according to claim 15,
wherein the display control unit changes text or a value displayed in the other input field in accordance with an operation performed on the software keyboard or the increase and decrease keys.

18. A non-transitory computer readable medium storing a program causing a computer to execute a process comprising:
displaying an input field on a display unit;
receiving a user operation performed in the input field displayed on the display unit; and
displaying, on the display unit, if the user operation is received, a software keyboard and another input field corresponding to the input field in which the user operation has been performed.

19. A display apparatus comprising:
display means;
reception means for receiving a user operation performed in an input field displayed on the display means; and
display control means for, if the user operation is received, displaying, on the display means, a software keyboard and another input field corresponding to the input field in which the user operation has been performed.
